(19) United States
(12) Patent Application Publication
(10) Pub. No.: US 2005/0068720 A1
(43) Pub. Date: Mar. 31, 2005

(54) Drive cage clutch apparatus and method

(76) Inventors: Jeff A. Lambert, Cypress, TX (US); Pet W. Austin, Spring, TX (US); Juan M. Perez, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/673,824

(22) Filed: Sep. 29, 2003

(51) Int. Cl. G06F 1/16

(52) U.S. Cl. 361/685

(57) ABSTRACT

An apparatus comprises a movable drive cage coupled to a computer case. The drive cage houses a drive, and a clutch mechanism is attached to the computer case and is coupled to the drive cage. The clutch mechanism inhibits movement of the drive cage.

### BACKGROUND

A drive cage is an apparatus that is typically employed to house and/or secure various computer drives, e.g., hard drives, compact disc (CD) drives, or floppy drives, within a case, referred to hereafter as “computer case,” of a computing device. Typically, each drive is a separate component that is secured to the drive cage via an attachment mechanism, e.g., screws.

In addition to the various computer drives that are used in a computing device, the computing device also comprises a myriad of electronic components. Such components are oftentimes situated adjacent a drive cage and in close proximity to the drive cage within the computer case. Thus, sometimes a drive secured to the drive cage and/or the electronic components pivotal to the functioning of the computing device are obscured. Consequently, the drives and electronic components are often difficult to access and thus maintain.

Accordingly, as electronic components of computing devices have decreased in size, the computer case that houses the electronic components has also reduced in size. Thus, there is less and less physical space within the computer case to house not only the various drives and electronic components, but also the mechanical components that may be used to provide functionality within the computer case. As such, maintenance needed for components within computer cases has become increasingly difficult to effectuate. Therefore, in order to service or add new components to a computing device, it is often necessary to detach the drive cage from the computer case altogether.

### SUMMARY

Generally, embodiments of the present disclosure provide a drive cage clutch apparatus.

An apparatus in accordance with an embodiment of the present disclosure comprises a movable drive cage coupled to a computer case. In addition, the drive cage houses a drive, and a clutch mechanism is attached to the computer case and is coupled to the drive cage, such that the clutch mechanism inhibits movement of the drive cage.

A system in accordance with an embodiment of the present disclosure comprises a computer case and a drive cage pivotally coupled to the computer case. In addition, a clutch is rigidly coupled to the computer case and a coupling mechanism couples the drive cage to the clutch. The coupling mechanism and the clutch inhibit movement of the drive cage.

A method in accordance with an embodiment of the present disclosure comprises the steps of providing a drive cage that is pivotally coupled to a computer case. In addition, the method comprises moving the drive cage to a position, and retaining the drive cage, via a clutch, in the position.

### BRIEF DESCRIPTION OF THE DRAWINGS

FIG. 1A is a perspective view of a computer case drive cage clutch apparatus of the present-disclosure that is shown in an open position.

FIG. 1B is a perspective view of a drive cage clutch apparatus of the present disclosure having a hard drive attached thereto.

FIG. 1C is a perspective view of a computer case drive cage clutch apparatus of the present disclosure that is shown in a closed position.

FIG. 2 is a detailed view of the drive cage clutch apparatus of the present disclosure.

FIG. 3 is a detailed view of the drive clutch apparatus of the present disclosure.

FIG. 4A is an exploded view of the drive cage as shown in FIG. 1 of the present disclosure.

FIG. 4B is a perspective view of the drive cage as depicted in FIG. 4A of the present disclosure.

FIG. 5A is a plan view of the drive cage clutch of the present disclosure as shown in FIG. 1.

FIG. 5B is a side view of the drive cage clutch of the present disclosure as shown in FIG. 5A.

FIG. 5C is a cross sectional view of the drive cage clutch of the present disclosure as shown in FIG. 5A.

FIG. 5D is a bottom view of the drive cage clutch of the present disclosure as shown in FIG. 5A.

FIG. 5E is a perspective view of the drive cage clutch of the present disclosure as shown in FIG. 5A.

FIG. 6A is a plan view of the attachment assembly of the drive cage clutch of the present disclosure as shown in FIG. 4A.

FIG. 6B is a front view of the attachment assembly of the drive cage clutch of the present disclosure as shown in FIG. 6A.

FIG. 6C is a side view of the attachment assembly of the drive cage clutch of the present disclosure as shown in FIG. 6A.

FIG. 6D is a perspective view of the attachment assembly of the drive cage clutch of the present disclosure as shown in FIG. 6A.

FIG. 6E is a plan view of the drive cage clutch of the present disclosure as shown in FIG. 6A.

FIG. 7 is an exemplary method of the drive cage clutch of the present disclosure as depicted in FIG. 2.

### DETAILED DESCRIPTION

Generally an apparatus of the present disclosure enables exposure of electronic components and/or a hard drive of a computing device by moving a drive cage to a position that enables easy access to the electronic components and/or the hard drive. The apparatus of the present disclosure generally provides a handle and a clutch, wherein the handle is attached to the drive cage. The clutch is rigidly affixed to a computer case and, in turn is affixed to the drive cage, such that one can move the drive cage from one position to another, via the handle. As the handle is moved, e.g., in an upward direction, a coupling assembly, which couples the clutch to the drive cage, enables the movement, thereby enabling easy access to components that may be attached to the underside of the drive cage or components separate from the drive cage that may be obscured when the drive cage is completely closed within the case. Additionally, the clutch may use friction and/or ratcheting in order to retain the drive cage position during movement and retain the drive cage ultimately in an open position.

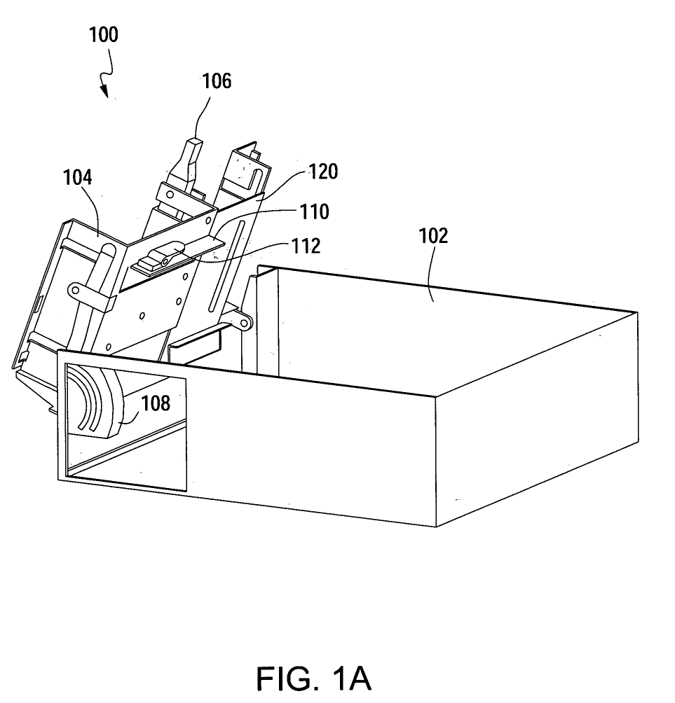

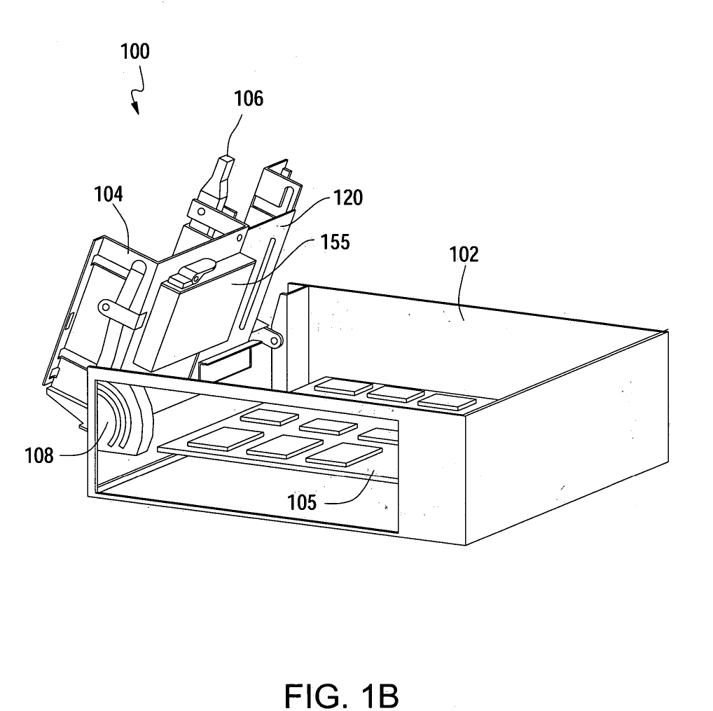

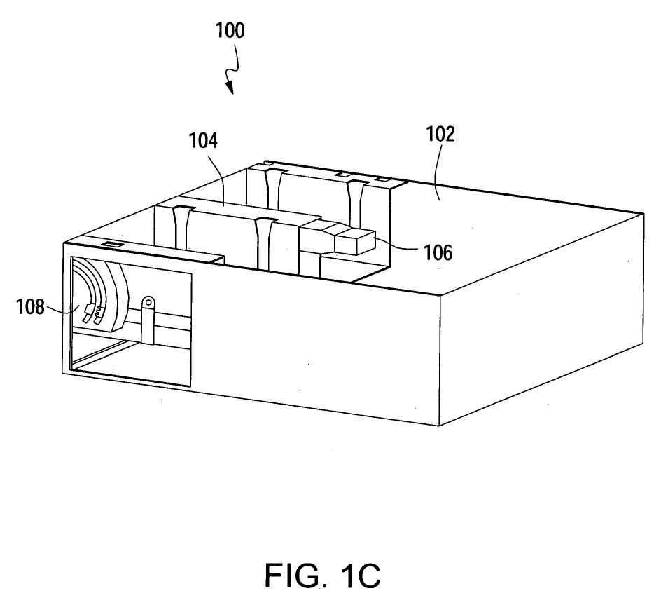

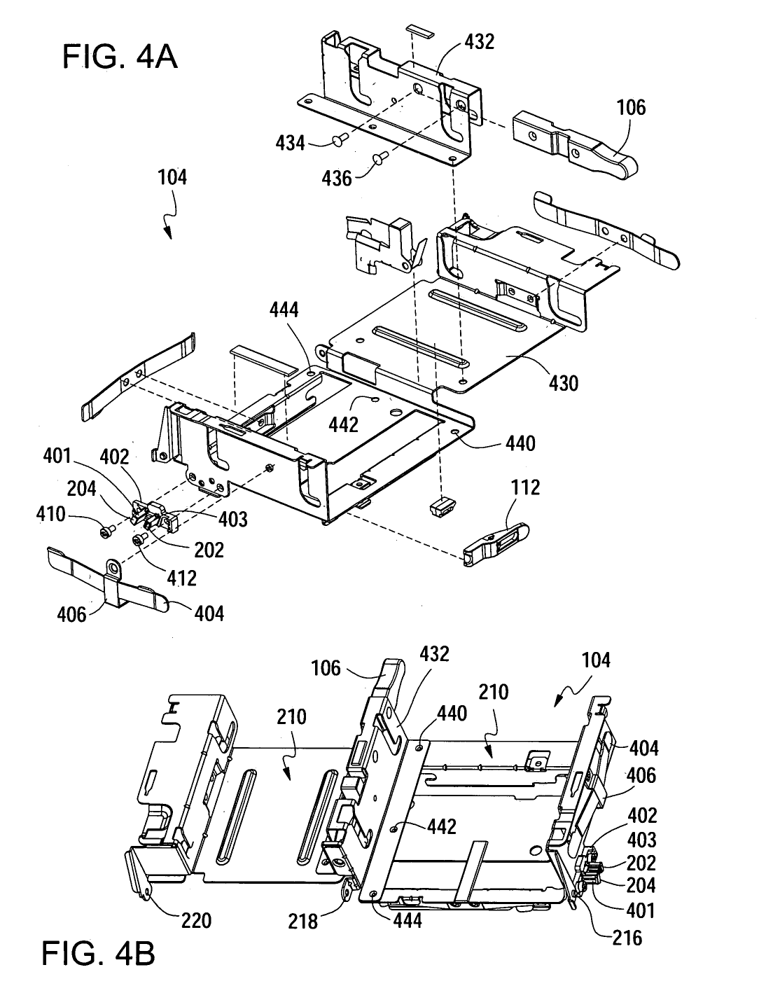

An embodiment of a drive cage assembly 104 of the present disclosure is illustrated in FIG. 1A. The system 100 comprises generally a computer case 102, a drive cage assembly 104, and a clutch 108. The assembly 104 comprises a handle 106 that is secured to the assembly 104. Attachment of the handle 106 to the assembly 104 is described in more detail with reference to FIGS. 4A and 4B. Note that the illustration of FIG. 1 shows the assembly 104 in an open position. Thus, in the open position, a component (not shown), such as a hard drive, for example, that may be attached to the underside 120 of the assembly 104 via an attachment mechanism 110 is readily accessible.

The clutch 108 is attached to the computer case 102, and it is coupled to the drive cage assembly 104. The clutch 108 may employ ratcheting and/or friction in order to retain the drive cage assembly 104 at any desired position between a closed position, illustrated in FIG. 1C, and the open position shown in FIG. 1A between the fully open and closed positions. Thus, at any intermediary position, as the drive cage travels, a user can discontinue pulling the handle, and the assembly 104 will remain in that intermediary position.

An exemplary attachment of a component, for example a hard drive, is now described in more detail with reference to FIG. 1B. During operation of the system 100, a hard drive 155 may be attached via the attachment mechanism 110. Note that the hard drive is preferably secured to an underside 120 of the drive cage assembly 104 via the attachment mechanism 110, which may comprise, for example, hooks (not shown) through which screws (not shown) may be inserted and a latch 112 may work in conjunction with the screws and the hooks to secure the hard drive 155 to the drive cage assembly 104. In this regard, the assembly 104, when in the open position of FIG. 1A and FIG. 1B, is situated such that the hard drive 155 affixed to the assembly 104 and also adjacent electronic components 105 are accessible to service personnel.

On the other hand, when the assembly 104 is in the closed position, as illustrated in FIG. 1C, the drive cage assembly 104 is situated within the case 102, which conceals the components 105, etc., within the case 102. When the drive cage assembly 104 is in the closed position illustrated, a user may grab the handle 106 and pull the handle 106 in an upward direction. In so pulling the handle 106, the drive cage assembly 104 rotates about a pivot axis to the open position, which is illustrated in FIG. 1A. The clutch 108 exerts force against such rotation.

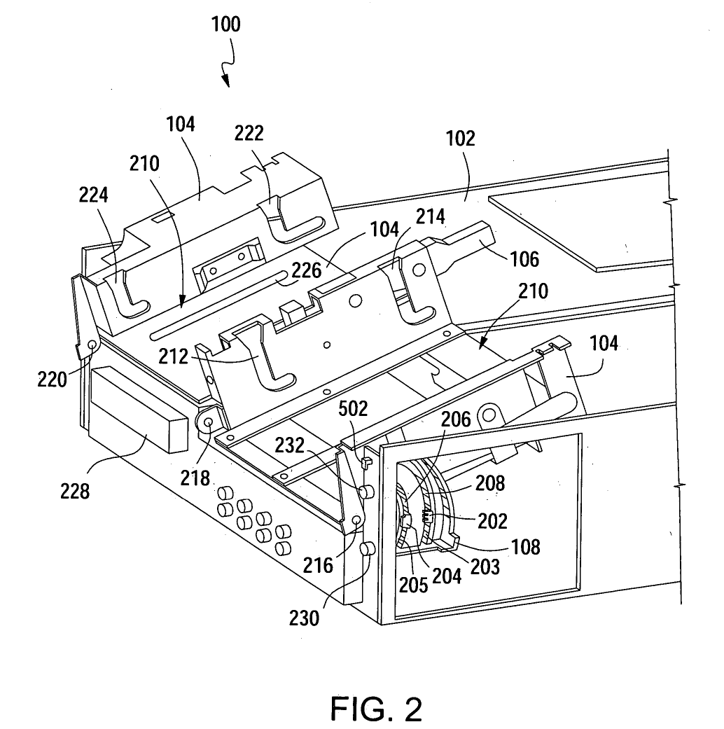

Another perspective view of the system 100 is depicted in FIG. 2. In an exemplary embodiment, the drive cage assembly 104 is pivotally attached to the case 102 at pivot points 220, 218, and 216. The drive cage assembly 104 rotates about a pivot axis defined by such points 220, 218, and 216, when the drive cage assembly 104 is moved in an upward or downward direction via the handle 106. The pivot points 220, 218, and 216 may comprise, for example, hinges, bushings, and/or shoulder screws. Note that other embodiments of the drive cage assembly 104 may employ other implements that enable the drive cage assembly 104 to be turned, rotated, or otherwise moved to other positions about pivot points 220, 218, and 216.

The drive cage assembly 104 preferably comprises at least one attachment mechanism 110, which secures drives 155 (FIG. 1B), e.g., CD drives, hard drives, floppy drives, zip drives, to the drive cage assembly 104. In this regard, the exemplary drive cage assembly 104 depicted in FIG. 2 comprises “J-slots” 224, 222, 212 and 214 that are able to accept and retain floppy drives. The drive that is being inserted may comprise a structural implement that fits securely into the J-slot(s) when it is installed. Further, the drive may be secured to the drive cage assembly 104, for example, by inserting a screw into the slot 226, which is secured to the drive positioned within a housing portion 210.

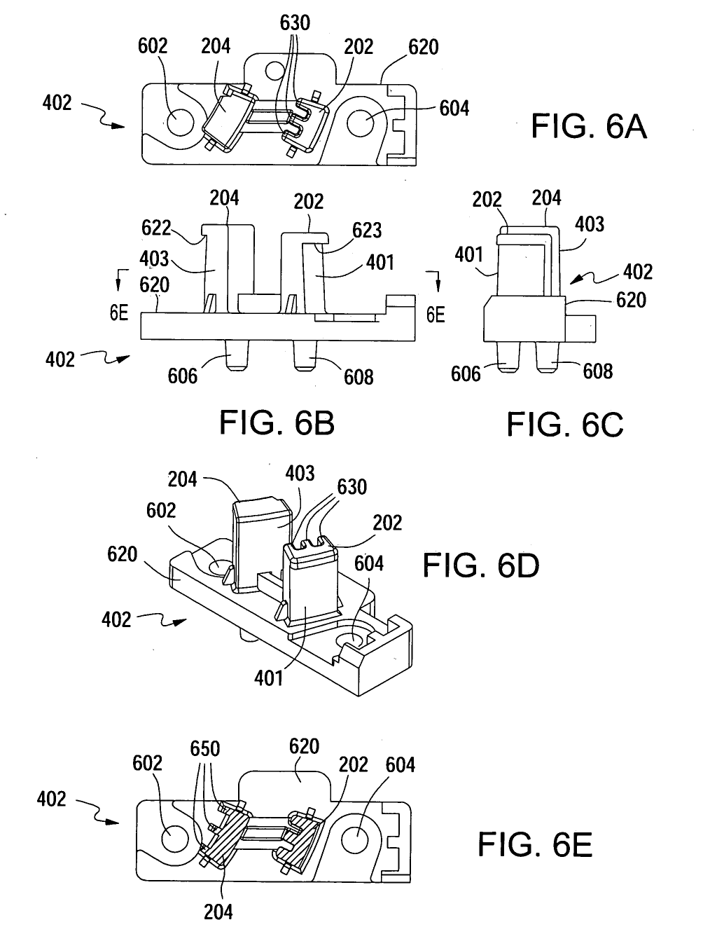

An embodiment of the clutch 108 is preferably in the shape of an arch, as shown, and the clutch 108 is preferably attached to the case 102 via screws 230 and 232, for example. Further, the clutch 108 preferably comprises two arced slots 206 and 208, which correspond to the shape of the arch of the clutch 108. The slots 206 and 208 receive tabs 202 and 204, which are attached to an attachment mechanism (not shown in FIG. 2). The attachment mechanism is described in more detail with reference to FIG. 6A-FIG. 6E. The tabs 202 and 204 are installed such that they are slidably coupled to the slots 206 and 208.

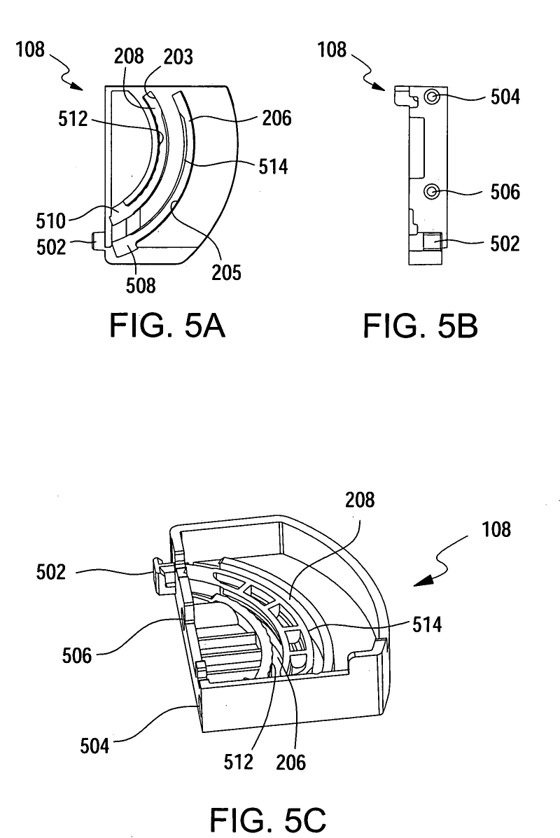

Thus, when the e cage assembly 104 is in the closed position, the tabs 202 and 204 are positioned at the bottom of the slots 206 and 208. As the drive cage assembly 104 is rotated about the pivot points 220, 218 and 216, the tabs 202 and 204 move along the arch of the slots 206 and 208. When at any point along the arced slots 206 and 208, the drive cage assembly 104 stops, the drive cage assembly 104 is retained in the position where the stop occurs by the tabs 202 and 204 in conjunction with clutch 108 that may employ friction and/or ratcheting, which is described in more detail with reference to FIG. 5A-5E. In this regard, the tabs 202 and 204 are, displaceably coupled to walls 203 and 205 of the slots 208 and 206, respectively, in a manner which inhibits movement, either in an upward or downward direction. Therefore, if movement of the drive cage assembly 104 ceases at the position indicated in FIG. 2, the drive cage assembly 104 will remain in that position until affirmative action is taken on the part of a user opening or closing drive cage assembly 104 by applying force to the handle 106. Thus, if one is performing maintenance either on the drive (not shown) that may be situated and attached to the underside of the cage assembly 104 or electronic components situated within the case 102, then the drive cage assembly 104 is prohibited from falling, thereby decreasing the risk of damage to any drives installed on the drive cage assembly 104 and increasing the ease with which maintenance can be performed within the case 102.

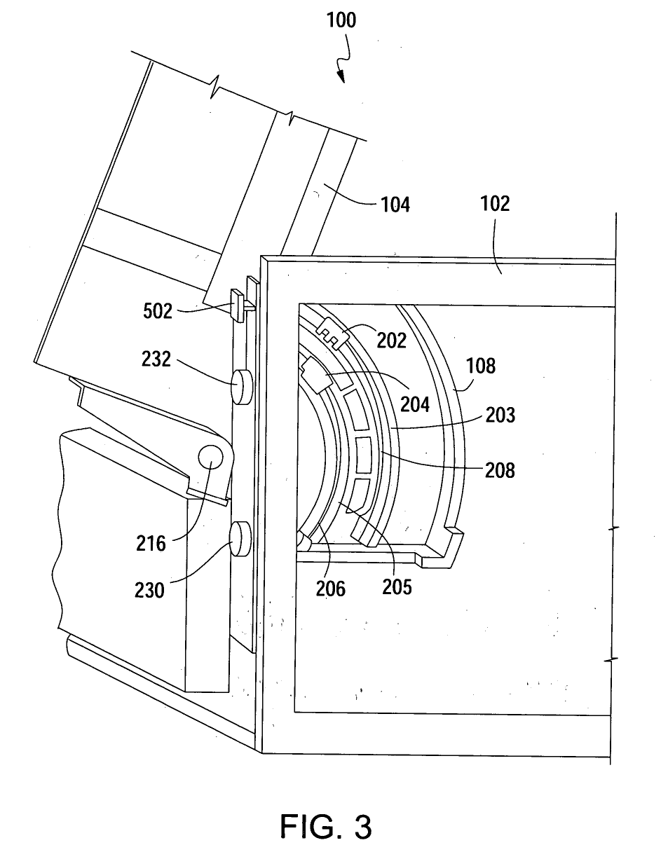

FIG. 3 depicts an enlarged view of that portion of system 100 comprising the clutch 108. FIG. 3 illustrates the position of the tabs 202 and 204 when the drive cage assembly 104 is in a nearly full open position. As indicated, the tabs 202 and 204 are located closer to the top of the arced slots 206 and 208. Thus, by way of example, as the drive cage assembly 104 is moved from an open to a closed position, the tabs will travel from their position at the top of the arced slots 206 and 208, as is illustrated in FIG. 3, to the bottom of the arced slots 206 and 208 when the drive cage is in a closed position. Note that as described in this embodiment movement of the drive cage assembly 104 is about the pivot points 216, 218 (FIG. 2), and 220 (FIG. 2). In other embodiments the motion may be rectilinear or a combination of rectilinear and rotational displacement.

FIG. 4A and FIG. 4B illustrate an exploded view of an exemplary drive cage assembly 104. The drive cage assembly 104 comprises a mounting frame 430 to which other components of the assembly 104 are secured. The handle 106 fits within the handle housing 432 and is secured to the housing 432 via screws 434 and 436. The handle housing 432 is then secured to the mounting frame 430 preferably via screws at mounting points 440, 442, and 444. In addition, a hard drive 155 (FIG. 1B) may be secured to the mounting frame 430 via the attachment mechanism 110, as described herein. Thus, when the drive 155 (FIG. 1B) is slid into an appropriate position, the latch 112 automatically opens, and when the drive 155 is in its final position the latch closes automatically thereby securing the hard drive 155. Note that the foregoing describes an exemplary installment and mechanism. Other various methods and mechanisms may be used to secure the drive to the underside 120 (FIGS. 1A and 1B) of the cage assembly 104.

A clutch coupling mechanism 402 preferably comprising the tabs 202 and 204 of coupling prongs 401 and 403 attaches to the mounting frame 430 via screws 410 and 412. The clutch coupling mechanism 402 is described in more detail with reference to FIG. 6A-FIG. 6E.

FIG. 4B shows a perspective view of an assembled drive cage assembly 104. The handle 106 is located within the housing 432 that is attached to the frame 430 via screws at mounting points 440, 442, and 444. Further, the coupling mechanism 402 attaches to the frame 430, such that the prongs 401 and 403 are positioned enabling the tabs 202 and 204 to be exposed for coupling to the clutch 108 (FIG. 2). Preferably, the prongs 403 and 401 extend away from and beyond a perimeter defining the drive cage assembly 104, so that when coupling the clutch 108 to the drive cage assembly 104, the clutch 108 sits adjacent to the drive cage 104, yet does not come in contact with the frame 430, except the coupling to the prongs 403 and 401.

The clutch 108 is now described in more detail with reference to FIG. 5A through FIG. 5C. FIG. 5A is a plan view of the clutch 108. As described herein, clutch 108 comprises arced slots 206 and 208 through which the tabs 203 (FIG. 2) and 204 (FIG. 2) of the coupling mechanism 402 (FIG. 4) travel during movement of the drive cage assembly 104 (FIG. 2). Each of the arced slots 206 and 208 has a portion 508 and 510 that is preferably larger in size to accommodate insertion of the tabs 204 and 202, respectively. Thus during installation, the tabs 202 and 204 are inserted into the openings 510 and 508. In this regard, the dimensions of each slot 206 and 208 preferably are defined by the dimensions of each of the respective tabs 202 and 204, and the portions 508 and 510 are preferably contiguous with and/or a part of the slots 206 and 208.

In addition, the exemplary clutch 108 comprises a ledge 514 and a ratcheted ledge 512. Preferably, the ledge 514 cooperates with tab 202, such that friction is produced between the tab 202 and the ledge 514. Such friction between ledge 514 and tab 202 tends to inhibit movement of the drive cage assembly 104, thus providing retention that, in turn, retains the drive cage assembly 201 in at least one intermediary position, i.e., a position between full closed and full open, or in a full open position.

Further, tab 204 may comprise teeth, described in more detail with reference to FIG. 6A, that engage the ratcheted ledge 512. Preferably, the ledge 512 cooperates with the tab 204, such that movement of the tab 204 along the slot 206 is inhibited. Such inhibition caused by the interaction between the tab 204 and the ratcheted ledge 512 further serves to inhibit movement of the drive cage assembly 104 and retain the drive cage assembly 104 in an intermediary position.

Therefore, one who is installing the clutch 108 inserts the tabs 202 and 204 into the openings 508 and 510, respectively, such that the drive cage assembly 104 is in an open position, initially. After insertion of the tabs 202 and 204 through the openings 508 and 510 of the clutch 108, the drive cage assembly 104 is moved in a downward direction, i.e., moved toward the closed position. As the drive cage assembly is moved downward, the tabs 202 and 204 travel from a position at the top of the clutch 108 and engage the walls 205 and 203 of the slots 206 and 208.

The tabs 202 and 204 then cooperate with the clutch 108, when moved in a downward position, to grasp the clutch 108 and secure the coupling mechanism 402 to the clutch 108 via coupling with the ledges 512 and 514. Further, the clutch 108 may comprise a male connector 502 that inserts into an opening (not shown) within the case 102 in order to further effectuate align the clutch 108 with the case 102 and affix the clutch 108 to the case 102.

With reference to FIG. 5B, in addition to the connector 502, the clutch 108 may have screw holes 504 and 506, which are positioned to receive attachment screws (not shown), which further effectuate aligning and attaching the clutch 108 to the case 102.

FIG. 5C depicts a perspective view of the clutch 108 further illustrating the slots 206 and 208 through which tabs 202 and 204 (FIG. 2) travel during movement of the drive cage assembly 104. Further shown are the connector 502 and the screw holes 504 and 506 in relation to the arced slots 206 and 208.

The coupling mechanism 402 is now described in more detail with reference to FIG. 6A through FIG. 6E.

FIG. 6A depicts a top view of the coupling mechanism 402. The coupling mechanism 402 comprises a base portion 620 having holes 602 and 604 for receiving screws 410 (FIG. 4A) and 412 (FIG. 4A). The screws 410 and 412 are attached to the frame 430 (FIG. 4A) to secure the coupling mechanism 402 to the drive cage assembly 104.

The coupling mechanism 402 further comprises the tabs 202 and 204, described herein with reference to FIG. 2. Such tabs 202 and 204 may be integral with prongs 401 (FIG. 4) and 403 (FIG. 4), which are preferably affixed to the base portion 620, or the tabs 202 and 204 may be separate components that are secured to the prongs 401 and 403.

Note that the E-shaped portion 630 of the tab 202 provides more flexibility to the tab 202. The flexibility assists in creating friction, which is caused by engagement of the tab 202 with the ledge 514 (FIG. 5C) of the slot 208 (FIG. 5C).

FIG. 6B depicts a side view of the coupling mechanism 402. The side view illustrates the prongs 401 and 403 attached to the base portion 620. Attachment to the base portion 620 of the prongs 401 and 403 may be effectuated via screws (not shown) inserted into receiving components 606 and 608. In such an embodiment, prongs 401 and 403 preferably comprise threaded openings for receiving the screws that may be inserted into the components 606 and 608. Note, however, that the specific attachment mechanism for securing the prongs 401 and 403 to the base portion 620 is not a pivotal aspect of the present disclosure. Therefore, various other attachment mechanisms may be used to secure the prongs to the base 620. Further note that in other embodiments, the base 620 and the prongs 401 and 403 may be comprised of the same material, and thus, may be a unitary piece. In such an embodiment, an attachment mechanism would not be necessary.

FIG. 6B further depicts the tabs 202 and 204 corresponding to the prongs 401 and 403, respectively. As noted herein, the tabs 202 and 204 may be integral with the prongs 401 and 403 or may be separate components. Further, each of the tabs 204 and 202 preferably comprises a projecting rim 622 and 623. The projecting rims 622 and 623 contact their respective ledges 514 and 512 of clutch 108 when the tabs 202 and 204 are inserted into openings 508 and 510 and moved into the slots 208 and 206.

In sliding the tab 204 through the slot 206, the rim 622 of the tab 204 comes in contact with the ledge 512. The contact of the ledge 512 of the clutch 108 with the rim 622 of tab 204 tends to create friction. Such friction tends to inhibit movement of the tab 204 along the ledge 512, which in turn inhibits movement of the drive cage assembly 104 to which the coupling mechanism 402 is attached.

In sliding the tab 202 through the slot 208, the rim 623 of the tab 202 comes in contact with the ledge 514. The contact of the ledge 514 of the clutch 108 with the rim 623 of tab 202 also tends to create friction. Such friction also tends to inhibit movement of the tab 202 along the ledge 514, which in turn inhibits movement of the drive cage assembly 104 to which the coupling mechanism 402 is attached.

In addition to employing friction to inhibit movement of the drive cage assembly 104, as described herein with reference to FIG. 5C, the clutch 108 may comprise a ratcheted ledge 512. Thus, at least one of the rims 622 or 623 may comprise a set of teeth for cooperating with the ratcheted ledge 512, which would further inhibit movement of the tab. This is discussed further with reference to FIG. 6C and FIG. 6E.

FIG. 6C depicts a side view of the coupling mechanism 402. The depiction in FIG. 6C again illustrates the prongs 401 and 403 and their respective tabs 202 and 204. Further shown in FIG. 6C are the rims 623 and 622. FIG. 6C indicates the relative difference in length of one prong 401 and the other prong 401. Such difference is not pivotal to the present disclosure, however, such design corresponds to the depth of the slots 206 and 208 in relation to the ledges 512 and 514 that the rims 622 and 623 contact in order to establish inhibited movement through the slots 206 and 208.

FIG. 6D depicts a perspective view of the coupling mechanism 402. In an exemplary embodiment, as shown in FIG. 6D, the prongs 401 and 403 and their respective tabs 202 and 204 are positioned substantially parallel with respect to one another, yet at an angle with respect to the base portion 620 of the coupling mechanism 402. Such positioning of the prongs 401 and 403 and the tabs 202 and 204 are preferably defined by the configuration of the clutch 108 to which the coupling mechanism shall be attached. In this regard, tabs 202 and 204 are preferably positioned, such that each is aligned with the openings 510 (FIG. 5A) and 508 (FIG. 5A) of the clutch 108. Further, the angular position of the prongs 401 and 403 are preferably such that as the drive cage assembly 104 (FIG. 2) is moved, the tabs 202 and 204 engage the walls 203 and 205 as the tabs 202 and 204 move along the slots 208 and 206.

FIG. 6E depicts a cross-sectional view of the coupling mechanism 108. Specifically, FIG. 6E illustrates an exemplary tab 204 having teeth 650. As described herein, the teeth 650 may be configured to engage the ratcheted ledge 512 (FIG. 5C), thereby further inhibiting movement of the tab 204 through the slot 206, which inhibits movement of the drive cage assembly 104. Inhibition of the movement of the drive cage assembly 104 decreases the risk that the assembly 104 will fall and damage hardware currently secured to the assembly 104, e.g., hard drives, floppy drives. In addition, it ensures easier and less time-consuming maintenance procedures performed on the computing system 100 (FIG. 1), because components are easier to reach.

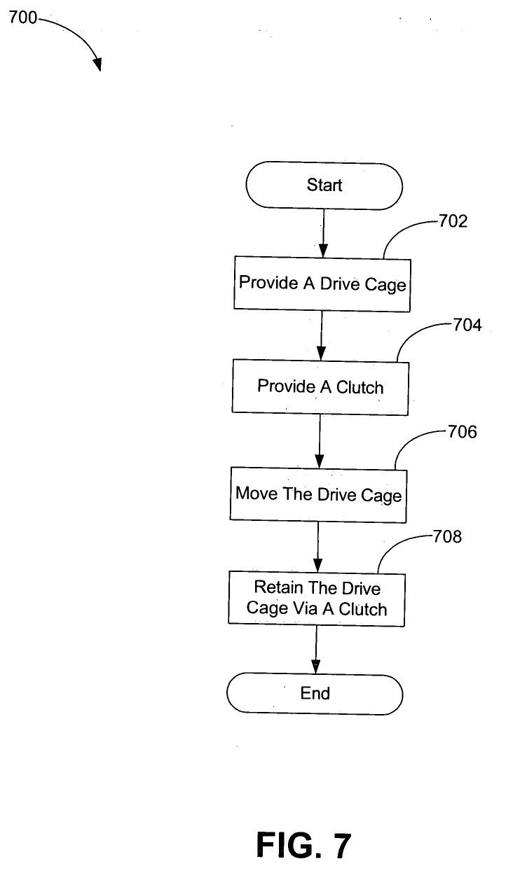

An exemplary method of the present disclosure is now described with reference to FIG. 7.

As indicated in step 702 and 704, the method encompasses providing a drive cage 104 (FIG. 1) and a clutch 108 (FIG. 1). The drive cage 104 is preferably pivotally coupled to a computer case 102 (FIG. 1), and the clutch 108 is coupled to the computer case 102 and the drive cage assembly 104.

As indicated in step 706, one moves the drive cage assembly 104. As described herein, movement of the drive cage assembly 104 may be accomplished via a handle 106. However, a handle is not pivotal to the aforedescribed disclosure. Further, movement can be in a upward or downward direction, depending upon whether one is attempting to open or close the drive cage assembly 104 for maintenance or installation purposes.

As indicated in step 708, the clutch 108 (FIG. 1) retains the drive cage in a desired position.

1. An apparatus, comprising:
a movable drive cage coupled to a computer case, the drive cage housing a drive; and
a clutch mechanism attached to the computer case and coupled to the drive cage, the clutch mechanism inhibiting movement of the drive cage.

2. The apparatus of claim 1, wherein the drive cage comprises a handle.

3. The apparatus of claim 1, wherein the clutch mechanism has a slot.

4. The apparatus of claim 3, wherein the clutch mechanism is coupled to the drive cage via a coupling mechanism, the coupling mechanism comprising a prong inserted into the slot.

5. The apparatus of claim 4, wherein the prong comprises a tab having a rim that is retained by the slot.

6. The apparatus of claim 5, wherein the slot is contiguous to a ledge, the ledge engaged with the rim of the tab when the prong is inserted into the slot.

7. The apparatus of claim 6, wherein friction produced via contact between the rim of the tab and the ledge inhibits movement of the drive cage.

8. The apparatus of claim 6, wherein the rim comprises teeth.

9. The apparatus of claim 8, wherein the ledge is ratcheted.

10. The apparatus of claim 9, wherein the teeth in contact with the ratcheted ledge inhibit movement of the drive cage.

11. A system, comprising:
a computer case;
a drive cage pivotally coupled to the computer case;
a clutch rigidly coupled to the computer case; and
a coupling mechanism coupling the drive cage to the clutch, the coupling mechanism and the clutch inhibiting movement of the drive cage.

12. The system of claim 11, wherein the drive cage comprises a handle.

13. The system of claim 11, wherein the drive cage is pivotally attached to the computer case via shoulder screws.

14. The system of claim 11, wherein the clutch has a first slot and a second slot.

15. The system of claim 14, wherein the coupling mechanism comprises a first prong and a second prong, the first prong inserted into the first slot and the second prong inserted into the second slot, the first slot and the second slot adapted to inhibit movement of the drive cage when the first prong and the second prong, respectively, move through the first and second slot.

16. The system of claim 15, wherein the first prong comprises a rim.

17. The system of claim 16, wherein a ledge of the first slot contacts the rim of the first prong when the first prong is inserted into the first slot thereby inhibiting movement of the drive cage by friction created between the rim and the ledge.

18. The system of claim 16, wherein the rim comprises teeth in contact with a ratcheted ledge of the first slot.

19. The system of claim 18, wherein when the first prong is inserted into the first slot, the teeth contact the ratcheted ledge, thereby inhibiting movement of the drive cage.

20. An apparatus, comprising:
a drive cage pivotally attached to a computer case;
means for moving the drive cage; and
means for inhibiting movement of the drive cage.

21. The apparatus of claim 20, wherein the inhibiting means comprises a means for retaining the drive cage in an open position.

22. A method, comprising the steps of:
providing a drive cage pivotally coupled to a computer case;
moving the drive cage to a position; and
retaining the drive cage, via a clutch, in the position.
